(19) United States
(12) Patent Application Publication
(10) Pub. No.: US 2024/0410775 A1
(43) Pub. Date: Dec. 12, 2024

(54) ADAPTER FOR A SENSOR AND SENSOR COMPRISING A SENSOR ADAPTER

(71) Applicant: Kistler Holding AG, Winterthur (CH)

(72) Inventors: Michael Tester, Wallisellen (CH); Reinhold Hess, Winterthur (CH); Cyril Brian Hertz, Wolfhalden (CH)

(21) Appl. No.: 18/735,695

(22) Filed: Jun. 6, 2024

(30) Foreign Application Priority Data
Jun. 7, 2023 (EP) 23178045.3

(51) Int. Cl. G01L 23/28

(52) U.S. Cl. CPC G01L 23/28

(57) ABSTRACT

An adapter for circulating a fluid temperature conditioning medium to cool or heat a pressure sensor includes a supply line, a discharge line and a cavity defined by the adapter integrally with the supply line and the discharge line in a manner connecting the supply line and the discharge line in such a way that the fluid temperature conditioning medium can be circulated from the supply line through the cavity to the discharge line. A recess is defined by the adapter integrally with the supply line, the discharge line and the cavity and configured to receive the pressure sensor.

### FIELD OF THE INVENTION

The invention relates to an adapter for cooling or heating or temperature conditioning of a sensor.

### BACKGROUND OF THE INVENTION

In various areas of technology, for example in industry or scientific research, sensors detect physical properties of a fluid medium. Physical properties of a fluid medium are, for example, pressure, temperature, pH value, viscosity, compressibility or flow velocity. Many of these properties are temperature-dependent.

However, one important property to which the invention is by no means limited is the pressure of a fluid medium. The fluid medium the property of which is determined is referred to below as the measuring medium.

A measuring medium is a fluid medium in a gaseous or liquid state of aggregation or a mixture of gaseous and liquid states of aggregation. A measuring medium can be, for example, a gas or a liquid. A fluid medium is also, for example, a fuel-gas mixture in the combustion chamber of an internal combustion engine or, after at least partial combustion of the fuel, the resulting exhaust gas. A measuring medium can also be a working medium in a compressor, for example a heat pump or in a cooling compressor. A measuring medium can also be a gas, for example noble gases or also hydrogen.

In many cases, a measuring medium has a high temperature above 200° C. or a low temperature below 0° C.

A measuring medium can also have corrosive properties.

However, sensors for determining at least one physical property of a measuring medium are sensitive to a temperature that is too high or too low. Thus, a temperature that is too high or too low can falsify the measurement result due to a temperature dependency of a measuring element of the sensor. In particular, it may not be possible to determine a physical property with high accuracy if the temperature of the measuring medium changes. However, excessively high temperatures can also damage the sensor. In some piezoelectric materials, such as those used as measuring elements in pressure sensors, for example, irreversible changes occur at temperatures above 300° C. On the other hand, materials used in the sensor can become brittle if temperatures are too low. This can lead to cracking and destruction of the sensor.

In CH700534A1 a sensor is disclosed which is surrounded by a housing for cooling the sensor. The housing comprises an adapter for cooling a pressure sensor. The adapter comprises a supply line and a discharge line, each of which is connected to a cavity. A fluid cooling medium circulates from the supply line through the cavity to the discharge line. The adapter comprises a recess along a longitudinal axis to accommodate the pressure sensor. The cavity radially surrounds the recess.

Known adapters have the disadvantage that they significantly contribute to the size of a sensor temperature conditioned by means of an adapter. The combination of adapter and sensor, hereinafter referred to as the temperature conditioning combination, requires a larger measuring bore than a single sensor.

In many applications, the space around boreholes for pressure measurement is limited. The diameter of the bore itself is also often limited. Adapters made conventionally from turned and milled parts using machining production methods have a relatively large installation space. This means that relatively large, stable elements must be provided for connections between parts. Even with conventional manufacturing methods, elements to increase stability cannot simply be placed anywhere in the adapter. This leads to relatively large adapters.

An adapter generally exhibits a temperature conditioning capacity that depends on the pressure loss between the inlet and outlet and the resulting limited pressure-dependent flow rate. The more effective the heat energy transfer between the temperature conditioning medium and the adapter, the better the temperature conditioning performance. The pressure loss in turn largely depends on the geometry of the cavity and the cross-section of the supply and discharge. Up to now, an optimum cooling/heating capacity per available installation space has been difficult to realize.

### OBJECTS AND SUMMARY OF THE INVENTION

The object of the present invention is to protect a sensor from high or low temperatures by means of an adapter and to improve the adapter in such a way that the above-mentioned disadvantages are reduced. A further object is to manufacture an adapter as economically as possible.

The object is solved by the features described hereinafter.

The invention relates to an adapter for cooling or heating or temperature conditioning of a pressure sensor. The term cooling is understood to mean a process in which thermal energy, also referred to as heat energy or heat, is dissipated from the adapter or from a sensor arranged in the adapter, respectively. Thus, heat is withdrawn from the sensor. The term heating refers to a process in which thermal energy is supplied to the adapter or to a sensor arranged in the adapter, respectively. The term temperature conditioning refers to a process in which the temperature of an adapter or a sensor arranged in the adapter, respectively, is kept constant. Depending on the temperature, heat is withdrawn from or applied to the adapter.

In the following, the term “temperature conditioning” is used for the sake of simplicity. However, this also refers to cooling or heating.

The adapter comprises at least one supply line. The adapter comprises at least one discharge line. The supply line and the discharge line are lines for conducting a fluid temperature conditioning medium, or temperature conditioning medium for short. The supply line and discharge line are designed to be connected to a device, for example a cooling device, a heating device or a temperature conditioning device. Said temperature conditioning medium can be fed from the device through the supply line and from the discharge line back to the device. The adapter also comprises at least one cavity. The at least one supply line and the at least one discharge line are connected to the at least one cavity in such a way that said fluid temperature conditioning medium can be circulated from the supply line through the cavity to the discharge line.

In use, the adapter is inserted into a bore of an apparatus, a so-called measuring bore. The measuring medium is located inside the apparatus.

The adapter comprises a recess along a longitudinal axis to accommodate a sensor. The recess comprises a first end. The first end of the recess faces a measuring medium when the adapter is in use. The recess also comprises a second end. The second end usually faces a room with normal pressure. The sensor, for example a pressure sensor, can usually be inserted into the adapter through the second end. The sensor is arranged in the recess of the adapter in such a way that the adapter and sensor are connected in a thermally conductive manner. Thus, the adapter is arranged between the measuring bore and the sensor.

A fluid temperature conditioning medium is understood to be a liquid or a gas or a gas-liquid mixture. A fluid temperature conditioning medium contains, for example, an oil, liquid sodium, water, liquids with proportions of glycerol or ethylene glycol or ethanol or propylene glycol or another coolant, nitrogen, air, noble gases and other suitable cooling liquids. The temperature conditioning medium can be brought to a set temperature by the device. Alternatively, the device can also withdraw or apply a certain amount of thermal energy to the temperature conditioning medium.

For example, an adapter is used as a cooling adapter in CH700534A1 already mentioned above. In the aforementioned disclosure, the pressure of a hot measuring medium, more precisely outlet, combustion chamber, combustor and turbine pressures, is determined. The adapter is designed to be connected to a cooling device. Water is used as the temperature conditioning medium.

Adapters are known as heating adapters which, for example, measure pressures in refrigerating machines, more precisely in the compressor of a refrigerating machine. A temperature conditioning medium circulates in the cavity of the adapter. The temperature conditioning medium is intended to bring the adapter and the sensor located in the recess of the adapter to a higher temperature than the cold measuring medium. Therefore, the sensor is connected to the adapter in a thermally conductive manner.

The cavity of the adapter is designed in such a way that the temperature conditioning medium can flow around the recess. Flow around the recess means that the cavity, projected onto a plane perpendicular to the longitudinal axis, surrounds the longitudinal axis by 360°. The cavity can, for example, extend around the longitudinal axis as two helical tubes offset from each other, which are connected to each other at the first end of the adapter. The cavity therefore does not necessarily have to completely surround the recess in a plane perpendicular to the longitudinal axis.

According to the present invention, the adapter is implemented in an integrally formed manner. By integrally formed it is understood that the adapter is made of one material. Therefore, the integrally formed adapter is not assembled from several semi-finished products or several workpieces. This has the advantage that there is no need to adjust different workpieces in relation to each other when manufacturing an adapter. Thus, rejects due to inadequate adjustment are avoided.

Advantageously, the adapter is designed to be weld-free and solder-free.

Weld-free is understood to mean that the adapter does not comprise weld seams which seal the adapter. Thus, for example, conduits are often made from a bent rectangular piece of sheet metal, one side of which is bent together with the opposite side and provided with a weld seam. The integrally formed adapter does not contain such weld seams. This is advantageous as weld seams are susceptible to corrosion and can contribute to material fatigue, for example through hydrogen embrittlement. Weld seams and welds are also disadvantageous, as they are often subject to mechanical stresses due to the welding process of two solid surfaces, especially when the temperature of the surrounding material changes. Mechanical and/or thermal stress can lead to the formation of cracks and ultimately to the failure of a welded adapter. The same applies, mutandis mutatis, to soldered connections. The weld-free and solder-free adapter is therefore more resistant than an adapter with welded connections.

Advantageously, the adapter is manufactured using an additive manufacturing process. An additive manufacturing process is characterized by the fact that the component to be manufactured is produced layer by layer by adding at least one material. In this context, the component to be manufactured is the adapter. In additive manufacturing processes, also known as 3D printing technology or 3D printing, the material is joined together, usually layer by layer, to create a component workpiece from 3D model data. In some additive manufacturing processes, the components to be produced are manufactured directly in all three spatial directions. In most cases, however, production is carried out layer by layer, whereby one layer of the component is first produced in mainly two spatial directions. By adding further layers in the third spatial direction, the part can be produced in a three-dimensional manner.

Additive manufacturing processes, often synonymously referred to as generative manufacturing processes, are described in standard DIN EN ISO 52900:2022-03 and in Chapter 3 of the publication: acatech-Deutsche Akademie der Technikwissenschaften, Nationale Akademie der Wissenschaften Leopoldina, Union der deutschen Akademien der Wissenschaften (Hrsg.) (2016): “Additive Manufacturing”, Munich, ISBN: 978-3-8047-3676-4 (English version at: acatech-National Academy of Science and Engineering, German National Academy of Sciences Leopoldina, Union of the German Academies of Sciences and Humanities (Editors) (2017): “Additive Manufacturing”, Munich, ISBN: 978-3-8047-3677-1).

Well-known additive manufacturing processes include filament deposition modeling (FDM), also known as fused deposition modeling (FDM) or fused layer manufacturing/modeling (FLM), binder printing (3DP), layered object modeling (LOM), also known as Layer Laminated Manufacturing (LLM) or Sheet Lamination, Stereolithography (SLA, STL), Poly-Jet-Modelling (PJM), Plastic Laser Sintering (SLS, Selective Laser Sintering), also known as Polymer Laser Melting.

Powder bed-based additive manufacturing processes are particularly suitable for metallic materials. In this process, the material is applied as a powder layer and then selectively melted under heat. After subsequent solidification, excessive unmelted material is removed. Examples of powder bed-based additive manufacturing processes for metallic materials include laser beam melting (SLM, (Selective Laser Melting) or Direct Metal Laser Sintering (DMLS) or LaserCUSING or Laser Metal Fusion (LMF) or Direct Metal Printing (DMP) or Laser Beam Melting (LBM) or Direct Metal Laser Melting. As an alternative to heat input by a laser, electron beam melting (EBM) is also known.

Also known and suitable for metallic materials are additive manufacturing processes in which a powdered material is selectively guided as a gas stream to a specific position and melted, such as additive deposition welding (LMD, laser metal deposition) or direct metal deposition (DMD) or laser engineered net shaping (LENS) or electron beam-based additive manufacturing (EBAM).

The well-known screen printing process, which is also an additive manufacturing process, is particularly suitable for graphite. Thus green parts made of graphite or a ceramic material can first be additively manufactured and then sintered.

However, due to the rapid development time in the field of additive manufacturing processes, other additive manufacturing processes are also conceivable.

The adapter produced by additive manufacturing methods is particularly advantageous compared to adapters produced conventionally by machining methods, since the cavity can be shaped free of any limitation by manufacturing methods. The cavity can therefore exhibit a complex geometry. For example, elements to increase stability, such as rods or bridges between the walls of the cavity, can be easily placed in suitable positions. This allows the walls of the adapter to be implemented in a thinner size. Thus, the cavity can be enlarged. Alternatively, with the same cavity volume, the adapter can be implemented in a smaller size than a conventionally manufactured adapter. The cooling/heating capacity of the adapter scales exponentially with the wall thickness between the cavity and the recess for the sensor.

Instead of the oval or round shape of the cavity of a conventional adapter, as disclosed in CH700534A1, the cavity can have a complex shape and be designed for optimized cooling/heating. Thus, only cavities with straight cooling channels, i.e. straight bores, can be realized in integrally formed conventional components. The adapter produced using additive manufacturing processes can, for example, have one or more helical or curved cooling channels as a cavity. Said channels can also be simply split into several partial channels or several partial channels can be combined into one channel. Of course, the cavity can also have an oval or round shape.

In the case of a pressure sensor, the sensor can be placed further in front due to the smaller installation space of the adapter. This leads to a better cooling performance of the adapter designed using additive manufacturing processes. In addition, the feed channel for feeding the measuring medium to the pressure sensor, the so-called pressure connection, can be designed in a shorter length, which has a positive effect on the cut-off frequency of the pipe oscillations that usually occur in the supply channel. Pipe oscillations are described by the well-known theory of the Helmholtz resonator and interfere with the measurement signal, especially when rapid pressure changes are to be determined.

The adapter made from an integrally formed piece using additive manufacturing processes is characterized by lower manufacturing costs, since various work steps, such as adjustment before assembly, assembly and welding, are eliminated compared to a conventional adapter.

In addition, conventionally machined adapters produce material as a waste product. Said waste is advantageously avoided with adapters made from a metallic material using additive manufacturing processes. The powdered metallic material is selectively melted or applied. Excessive powdered metallic material can be removed, collected and reused. This leads to lower manufacturing costs.

Further advantages and aspects of the invention are disclosed in the embodiments.

### BRIEF DESCRIPTION OF THE DRAWINGS

In the following, the present invention is explained in more detail by way of example with reference to the figures. The following is shown

FIG. 1 shows a schematic view of an embodiment of an adapter with a sensor arranged therein,

FIG. 2 shows a section of a schematic cross-sectional view in the direction of the arrows designated A-A in FIG. 1 of the adapter with the sensor arranged therein in the embodiment according to FIG. 1,

FIG. 3 shows a further section of a schematic sectional view in the direction of the arrows designated B-B in FIG. 2 of the adapter with the sensor arranged therein in the embodiment according to FIG. 1,

FIG. 4 shows a schematic perspective view of the adapter in the embodiment according to FIG. 1, wherein the recess, chamfers, conduit sections and external hex are not shown for the sake of clarity and internal features otherwise hidden from view are defined in dashed lines,

FIG. 5 shows a further schematic perspective view of the adapter in the embodiment according to FIG. 1, wherein the recess, chamfers, conduit sections and external hex are not shown for the sake of clarity and internal features otherwise hidden from view are defined in dashed lines,

FIG. 6 shows a schematic view of a further embodiment of an adapter with a sensor arranged therein,

FIG. 7 shows a section of a schematic cutaway view in the direction of the arrows designated C-C in FIG. 6 of the adapter with the sensor arranged therein in the embodiment according to FIG. 6,

FIG. 8 shows a further section of a schematic sectional view in the direction of the arrows designated D-D in FIG. 7 of the adapter with the sensor arranged therein in the embodiment according to FIG. 6,

FIG. 9 shows a schematic perspective view of the adapter in the embodiment according to FIG. 6, wherein the recess, chamfers, conduit sections and external hex are not shown for the sake of clarity and internal features otherwise hidden from view are defined in dashed lines,

FIG. 10 shows a further schematic perspective view of the adapter in the embodiment according to FIG. 6, wherein the recess, chamfers, conduit sections and external hex are not shown for the sake of clarity and internal features otherwise hidden from view are defined in dashed lines,

FIG. 11 shows a schematic view of a further embodiment of an adapter with a sensor arranged therein,

FIG. 12 shows a section of a schematic sectional view in the direction of the arrows designated E-E in FIG. 11 of the adapter with the sensor arranged therein in the embodiment according to FIG. 11,

FIG. 13 shows a further section of a schematic sectional view in the direction of the arrows designated F-F in FIG. 12 of the adapter with the sensor arranged therein in the embodiment according to FIG. 11,

FIG. 14 shows a schematic perspective view of the adapter in the embodiment according to FIG. 11, wherein the recess, chamfers, conduit sections and external hex are not shown for the sake of clarity and internal features otherwise hidden from view are defined in dashed lines,

FIG. 15 shows a further schematic perspective view of the adapter in the embodiment according to FIG. 11, wherein the recess, chamfers, conduit sections and external hex are not shown for the sake of clarity and internal features otherwise hidden from view are defined in dashed lines,

FIG. 16 shows a schematic view of a further embodiment of an adapter with a sensor arranged therein,

FIG. 17 shows a section of a schematic sectional view in the direction of the arrows designated G-G in FIG. 16 of the adapter with the sensor arranged therein in the embodiment according to FIG. 16,

FIG. 18 shows a further section of a schematic sectional view in the direction of the arrows designated H-H in FIG. 17 of the adapter with the sensor arranged therein in the embodiment according to FIG. 16,

FIG. 19 shows a schematic perspective view of the adapter in the embodiment according to FIG. 16, wherein the recess, chamfers, conduit sections and external hex are not shown for the sake of clarity and internal features otherwise hidden from view are defined in dashed lines,

FIG. 20 shows a further schematic perspective view of the adapter in the embodiment according to FIG. 16, wherein the recess, chamfers, conduit sections and external hex are not shown for the sake of clarity and internal features otherwise hidden from view are defined in dashed lines,

FIG. 21 shows a schematic view of a further embodiment of an adapter with a sensor arranged therein,

FIG. 22 shows a section of a schematic sectional view in the direction of the arrows designated J-J in FIG. 21 of the adapter with the sensor arranged therein in the embodiment according to FIG. 21,

FIG. 23 shows a further section of a schematic sectional view in the direction of the arrows designated K-K in FIG. 22 of the adapter with the sensor arranged therein in the embodiment according to FIG. 21,

FIG. 24 shows a further section of a schematic sectional view of the adapter with the sensor arranged therein in the embodiment according to FIG. 21,

FIG. 25 shows a further schematic perspective view of the adapter in the embodiment according to FIG. 21, wherein the recess, chamfers, conduit sections and external hex are not shown for the sake of clarity and internal features otherwise hidden from view are defined in dashed lines,

FIG. 26 shows a schematic representation of a three-dimensional structure as a triply periodic minimal surface (TPMS),

FIG. 27 shows a sectional view of a schematic representation of the three-dimensional structure according to FIG. 26,

FIG. 28 shows a further sectional view of a schematic representation of the three-dimensional structure according to FIG. 26,

FIG. 29 shows a perspective view of a schematic representation of the three-dimensional structure according to FIG. 26, and

FIG. 30 shows a section of a sectional view of an embodiment of an adapter, wherein a three-dimensional structure is shown in the cavity.

### DETAILED DESCRIPTION OF EXEMPLARY EMBODIMENTS OF THE INVENTION

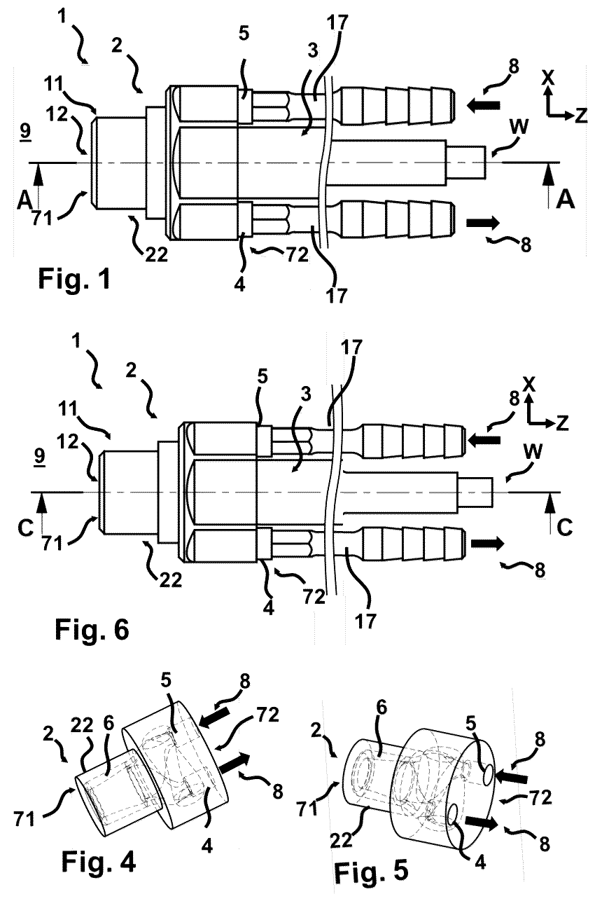

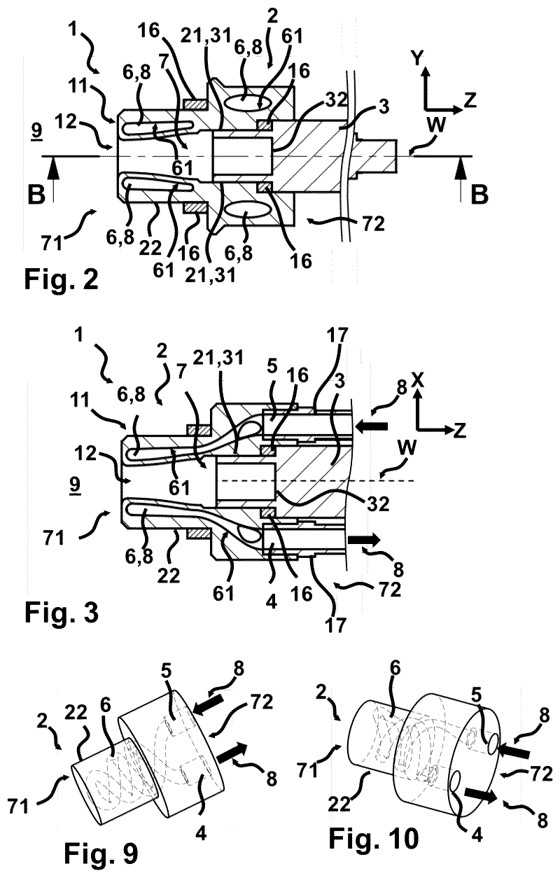

FIG. 1 shows an embodiment of a temperature conditioned sensor 1. The temperature conditioned sensor 1 comprises an adapter 2 for cooling or heating or temperature conditioning of a pressure sensor 3, as well as the pressure sensor 3. The adapter 2 comprises a supply line 4. The adapter 2 comprises a discharge line 5. As shown in the cross-sectional views of FIGS. 2 and 3 and the dashed line phantom view of FIG. 6, the adapter 2 also comprises a cavity 6. The supply line 4 is connected to the cavity 6. The discharge line 5 is also connected to the cavity 6. The connection of supply line 4, discharge line 5 and cavity 6 is designed in such a way that a fluid temperature conditioning medium 8 can be circulated from the supply line 4 through the cavity 6 to the discharge line 5.

In the exemplary embodiment shown in FIG. 1, conduit sections 17 are attached to said supply line 4 and discharge line 5, by means of which the adapter 2 can be connected to a device (not shown), for example a cooling device, a heating device or a temperature conditioning device.

The adapter 2 is connected to a pressure sensor 3. The connection can be made by form-fit, force-fit or material-fit. Pressure sensor 3 and adapter 2 are preferably connected to each other via connecting means 21, 31 shown in FIGS. 2 and 3 for example. For example, the pressure connection 11 comprises an external thread 21 as connecting means 21, while the adapter 2 has a corresponding internal thread 31 as connecting means 31. A sealing element 16 can be arranged between the adapter 2 and the pressure sensor 3, which prevents the measuring medium 9 at the first end 71 of the adapter 2 from penetrating to the second end 72 of the adapter 2. Alternatively, connecting means 21, 31 can also be designed as a bayonet closure. In a further embodiment, the connecting means 21, 31 can also be designed as a welded connection or soldered connection. A welded connection has the advantage that sealing element 16 is not required between pressure sensor 3 and adapter 2.

The adapter 2 of FIG. 1 comprises an optional pressure connection 11, which faces the measurement medium 9 when in use. The pressure connection 11 delivers the measuring medium 9 to the pressure sensor 3.

Said pressure sensor 3 and adapter 2 are arranged in an alignment that lies along a longitudinal axis Z. The pressure sensor 3 extends largely along the longitudinal axis Z. A first transverse axis X and a second transverse axis Y extend perpendicular to the longitudinal axis Z, with the first transverse axis X being perpendicular to the second transverse axis Y.

FIG. 2 shows a sectional view AA of a part of the embodiment of the cooled sensor 1 comprising adapter 2 and pressure sensor 3 from FIG. 1 along the plane defined by the longitudinal axis Z and the second transverse axis Y. In this and all other sectional views, the pressure sensor 3 is shown in a highly simplified form with uniform hatching for the sake of clarity.

Said adapter 2 comprises a recess 7 formed along the longitudinal axis Z and configured for receiving a pressure sensor 3. The recess 7 comprises a first end 71 which, when in use, faces the measuring medium 9. The recess 7 comprises a second end 72. For example, the pressure sensor 3 can be inserted into the second end 72 in order to be arranged in the recess 7.

The pressure sensor 3 generally comprises a pressure-sensitive surface 32 depicted schematically in FIGS. 2 and 3 for example. The pressure-sensitive surface 32 is usually designed as a diaphragm 32.

The cavity 6 is configured to surround the recess 6 in such a way that the temperature conditioning medium 8 can flow around the recess 7 in a recirculating manner. In the embodiment of FIGS. 1 to 3, the cavity 6 is designed as a largely rotationally symmetrical channel 6 with respect to the longitudinal axis Z and defines a portion having an oval cross-section in the vicinity of the second end 72 of the adapter 2. The portion of the cavity 6 disposed in the vicinity of the first end 71 of the adapter 2 forms a channel 6 having an elongated cross-section that is largely rotationally symmetrical with respect to the longitudinal axis Z. As can be seen in the sectional view BB along the longitudinal axis Z and the first transverse axis X of a partial view of the embodiment of the temperature conditioned sensor 1 of FIG. 1 in FIG. 3, both channels are connected to form a cavity 6. Part of the cavity 6 in the form of the channel with an elongated cross-section is arranged in the pressure connection 11 of the adapter 2 and surrounds the supply channel 12. This allows temperature conditioning of the measuring medium 9 in the supply channel 12. A further part of the cavity 6 in the form of the channel with an oval cross-section is arranged at the position of the pressure sensor 3 with respect to the longitudinal axis Z and surrounds the front pressure-sensitive part 32 of the pressure sensor 3 with respect to the longitudinal axis Z. It should be noted that such a division of the cavity 6 into two largely rotationally symmetrical channels is not necessary at all. It is also conceivable to have no division of the cavity 6, a division of the cavity 6 into two channels or even a division of the cavity 6 into two or more than two channels. From this description, the person skilled in the art is informed of the suggestion to provide a cavity 6 with one or more channels that are not largely rotationally symmetrical. These options are also part of the present invention.

Several supply lines 4 and/or several discharge lines 5 may also be conceivable.

According to the present invention, the adapter 2 of the embodiment of FIG. 1 to FIG. 3 is implemented in an integrally formed manner as a unitary element. Therefore, the conduit sections 17 are not part of the adapter 2 in this embodiment. However, it is easily possible to implement the conduit sections 17 in an integrally formed manner with the adapter 2 as well.

FIG. 4 and FIG. 5 show a perspective view of the adapter 2 from FIGS. 1 to 3. For reasons of clarity, the adapter 2 is shown without conduit sections 17, without chamfers, without external hex and without pressure sensor 3. The cavity 6 inside the adapter 2 is shown as a dashed line. The openings for the supply line 4 and discharge line 5 are located at the second end 72. In this embodiment of the adapter 2, the cavity 6 is mainly implemented as two torus-like channels running around the recess 7, which are each connected to the supply line 4 and discharge line 5 on opposite sides with respect to the first transverse axis X.

In the further embodiments described below, elements with the same functions as in the embodiment already described in FIGS. 1 to 5 are each designated with the same reference numerals.

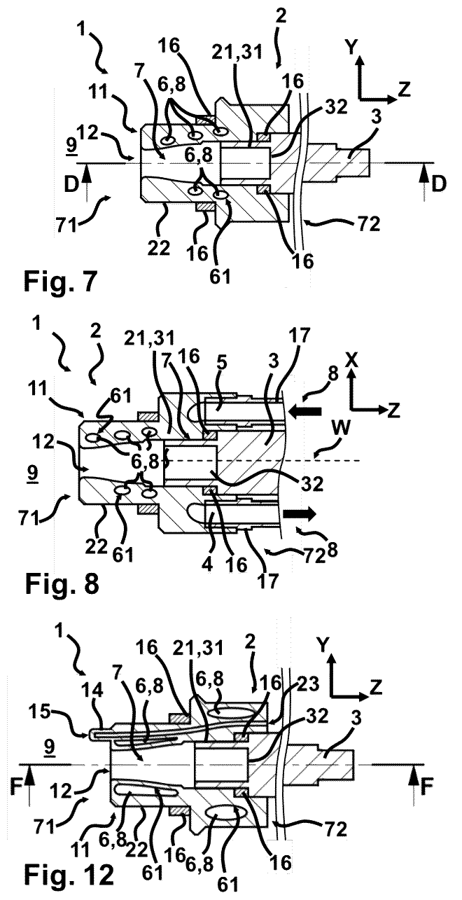

FIG. 6 shows a further embodiment of an adapter 2 with a pressure sensor 3 arranged in the adapter 2. FIG. 7 shows a section of a schematic sectional view CC along the second transverse axis Y and the longitudinal axis Z of the view in FIG. 6. Apart from the design of the cavity 6, the adapter 2 is identical to the embodiment of the adapter 2 of FIGS. 1 to 3. The cavity 6 exhibits the form of a tubular channel which extends along two helical lines from the first end 71 of the adapter 2 to the second end 72 of the adapter 2 of the second side 72. The channel starts at the supply line 4, which is shown in FIG. 8, and extends helically to the second side 72. In front of the second side 72, the channel extends helically again to the first end 71 where it is connected to the discharge line 5. The cavity 6 is formed by the double helical channel. In a projection of the cavity 6 onto the plane XY perpendicular to the longitudinal axis Z, the cavity 6 encloses the longitudinal axis Z and thus the recess 7 by 360°. The temperature conditioning medium 8 can flow around the recess 7 through the cavity 6. Such a cavity 6 is advantageously designed using the 3D printing processes already described. Conventional production using machining methods is virtually impossible. FIG. 9 and FIG. 10 show a perspective view of the adapter 2 from FIGS. 6 to 8. For reasons of clarity, the adapter 2 is shown without conduit sections 17, without chamfers, without external hex and without pressure sensor 3. The cavity 6 inside the adapter 2 is shown as a dashed line. The openings for the supply line 4 and discharge line 5 are located at the second end 72. The possible shape of the cavity 6 is recognizable in this illustration as two helical or spiral channels.

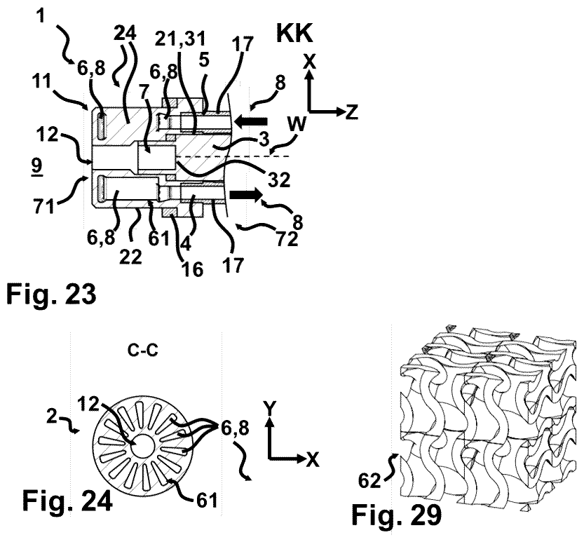

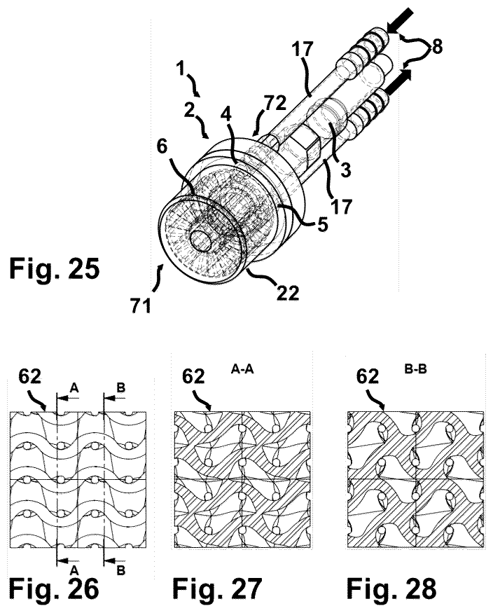

FIG. 21 shows a further embodiment of an adapter 2 with a pressure sensor 3 arranged in the adapter 2. FIG. 22 shows a section of a schematic sectional view JJ along the second transverse axis Y and the longitudinal axis Z of the view in FIG. 21. The part of the cavity 6 shown on the left in FIG. 22 near the first end 71 has the shape of a hollow cylinder. The lower part of the cavity 6 on the right in FIG. 22 exhibits the shape of a partial hollow cylinder extending less than 180° around the longitudinal axis Z, which is connected to the discharge 5. The upper right part of the cavity 6 in FIG. 22 exhibits the shape of a partial hollow cylinder extending less than 180° around the longitudinal axis Z, which is connected to the supply line 4. In FIG. 23, the section KK along the first transverse axis X and the longitudinal axis Z shows a connection between the left hollow cylinder and the right half hollow cylinder of the supply line 4. The area between the left hollow cylinder and the two right partial hollow cylinders is also largely hollow-cylindrical in shape, with several stability elements 24 connecting the inner wall of the hollow cylinder to the outer edge of the hollow cylinder and dividing the hollow cylinder into individual chambers, as shown in FIG. 24. Half of the chambers are connected to the supply line 4 at the second end 72, while the other half of the chambers are connected to the discharge 5 at the second end 72. The temperature conditioning medium 8 therefore flows in the chambers connected to the supply line 4 from the second end 72 to the first end 71 and in the chambers connected to the discharge line 5 from the first end 71 to the second end 72. The cavity 6 encloses the recess 7 in a projection of the cavity 6 onto the plane XY perpendicular to the longitudinal axis Z. Such an adapter 2 is similarly stable to the adapter 2 shown in FIGS. 1 to 3, but has a considerably larger cavity wall 61, at which heat exchange between the temperature conditioning medium 8 and the adapter 2 is possible. FIG. 25 shows a perspective view of the adapter 2 from FIGS. 21 to 24. The cavity 6 arranged inside the adapter 2 is shown with a dashed line. The openings for the supply line 4 and discharge line 5 are arranged at the second end 72.

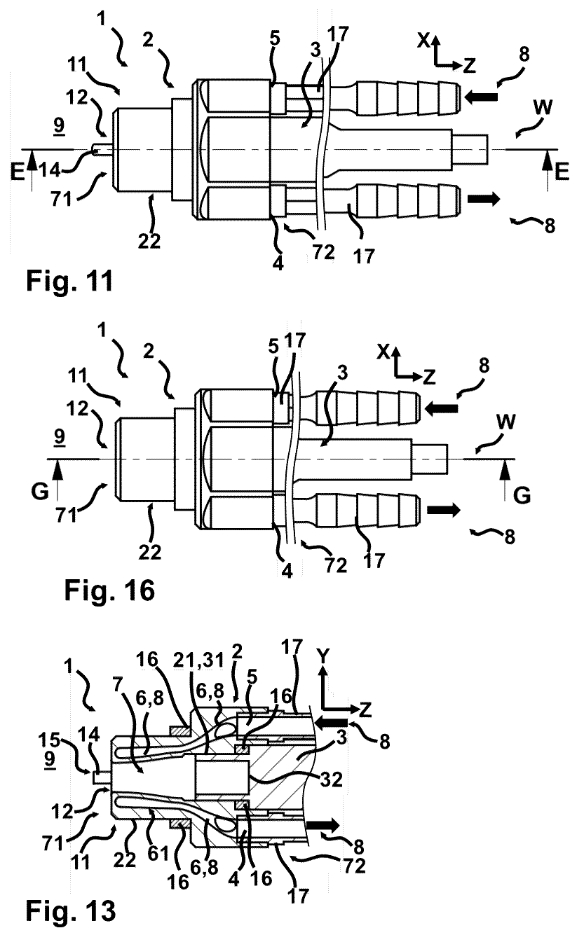

FIG. 11 shows a further embodiment of an adapter 2 with a pressure sensor 3 arranged in the adapter 2. The adapter 2 additionally comprises a sleeve 14. Said sleeve 14 is designed as a hollow protrusion at the first end 71 of the adapter 2, as shown in the section of a schematic sectional view EE along the second transverse axis Y and the longitudinal axis Z of the view in FIG. 11. The hollow sleeve 14 extends to the second end 72 of the adapter 2, where it ends in an opening 23, more precisely contact opening 23 such as shown in FIG. 17 for example. Said sleeve 14 is designed to accommodate a temperature sensor, which is not shown in FIG. 11 for the sake of clarity. However, the sleeve 14 is configured to receive a temperature sensor in a manner advantageously arranged close to the first end 71 of the adapter 2 and desirably located where the arrow designated 15 is pointing in FIGS. 12 and 13 for example. At this location 15, the sleeve is configured to protrude into the measuring medium when the adapter 2 is used, and the sleeve 14 is hermetically sealed with respect to the measuring medium. Electrical contacting through the contact opening 23 at the second end 72 of the adapter 2 is easy to implement.

Said sleeve 14 is arranged at least partially in the pressure connection 11. When using the adapter 2, the sleeve 14 protrudes at least partially into the measuring medium 9 and is hermetically or pressure-tightly sealed with respect to the measuring medium 9. This has the advantage that the area of the sleeve 14, which protrudes into the measuring medium 9 near the first end 71 of the adapter 2 and is intended to accommodate the temperature sensor at this location 15, is at least partially thermally decoupled from the pressure connection 11. Thus, the temperature of the measuring medium 9 can be determined and the influence of the temperature of the temperature conditioning medium 8 on the temperature sensor can at least be reduced.

A sleeve 14 can have an influence on the geometry of the cavity 6, as shown in FIG. 12. In this sectional view EE, the cavity 6 is slightly narrowed at the location of the sleeve 14. Such an adaptation of the geometry is advantageously easy to carry out using 3D printing. In the further sectional view FF along the longitudinal axis Z and the first transverse axis X shown in FIG. 13, it is shown that the cavity 6 in this plane is largely similar to the cavity 6 of the embodiment of FIG. 3.

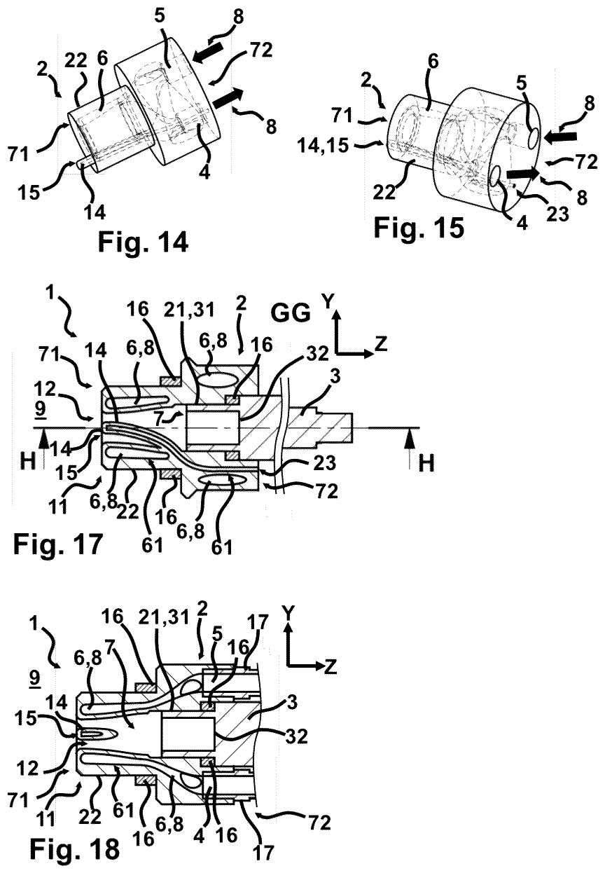

FIG. 14 and FIG. 15 show a perspective view of the adapter 2 of FIGS. 11 to 13. For reasons of clarity, the adapter 2 is shown without conduit sections 17, without chamfers, without external hex and without pressure sensor 3. The hollow space 6 arranged inside the adapter 2 is shown as a dashed line. The internally disposed features of the hollow sleeve 14 are shown partially dashed. The contact opening 23 is shown in FIG. 15. The openings for supply line 4 and discharge line 5 are arranged at the second end 72. In this embodiment of the adapter 2, the cavity 6 is mainly designed as two torus-like channels running around the recess 7, which are each connected to supply line 4 and discharge line 5 on opposite sides with respect to the first transverse axis X.

FIG. 16 shows a further embodiment of an adapter 2 with a pressure sensor 3 arranged in the adapter 2. Said adapter 2 additionally comprises a sleeve 14 in the supply channel 12 of the pressure connection 11, as shown in FIG. 17 in a sectional view GG along the second transverse axis Y and the longitudinal axis Z of the view in FIG. 16. Said sleeve 14 is designed as a hollow protrusion at the first end 71 of the adapter 2. The hollow sleeve 14 extends from the first end 71 within the feed channel 12 through an inner wall of the supply channel 12 to the second end 72 of the adapter 2, where it ends in a contact opening 23 that is shown in FIG. 17. The sleeve 14 is designed to accommodate a temperature sensor, which is not shown for the sake of clarity. However, similar to the location 15 shown in FIGS. 12 and 13, the temperature sensor is advantageously arranged near the first end 71 of the adapter 2. Electrical contacting through the contact opening 23 at the second end 72 of the adapter 2 can be implemented in an easy manner.

Said sleeve 14 is arranged at least partially in the pressure connection 11. When using the adapter 2, the sleeve 14 protrudes at least partially into the measuring medium 9 and is sealed with respect to the measuring medium 9 in a hermetical or pressure-tight manner. This has the advantage that the area of the sleeve 14, which protrudes into the measuring medium 9 near the first end 71 of the adapter 2 and is intended to accommodate the temperature sensor, is at least partially thermally decoupled from the pressure connection 11. Thus, the temperature of the measuring medium 9 can be determined and the influence of the temperature of the temperature conditioning medium 8 on the temperature sensor can at least be reduced.

Advantageously, in all described embodiments of the adapter 2 comprising sleeve 14, said sleeve 14 is integrally formed with the adapter 2. This is advantageous because the sleeve 14 is intrinsically sealed to the adapter 2. The disadvantages of welded seams already described are thus avoided.

As shown in the embodiment according to FIGS. 16 to 18, when manufactured using complex structures, the sleeve 14 can be guided in the adapter 2 in such a way that it has no influence on the geometry of the cavity 6. The cavity 6 of the embodiment shown in FIGS. 16 to 18 is designed in an identical manner to the cavity 6 of the embodiment shown in FIGS. 1 to 3.

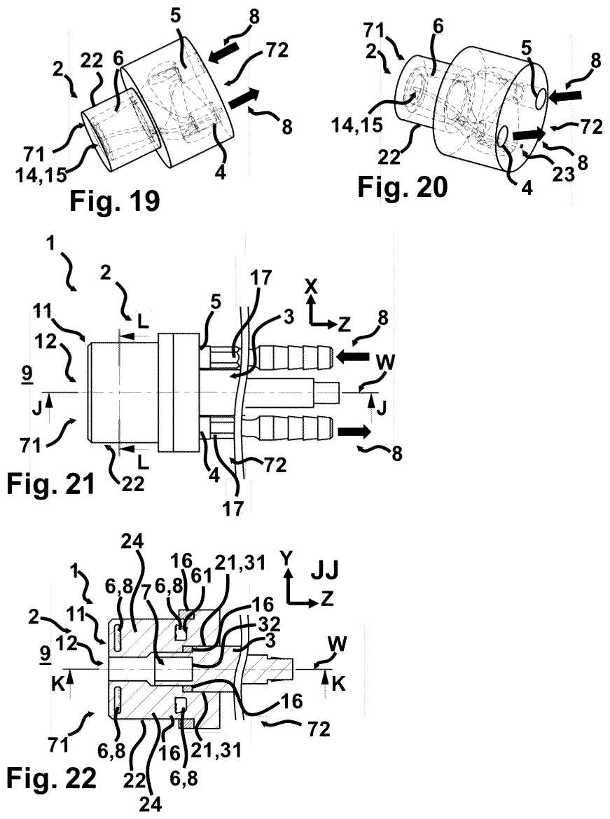

FIG. 19 and FIG. 20 show a perspective view of the adapter 2 from FIGS. 16 to 18. For reasons of clarity, the adapter 2 is shown without conduit sections 17, without chamfers, without external hex and without pressure sensor 3. The hollow space 6 arranged inside the adapter 2 is shown as a dashed line. The internally hollow sleeve 14 is shown partially dashed. The contact opening 23 is shown in FIG. 20. The openings for supply line 4 and discharge line 5 are arranged at the second end 72. In this embodiment of the adapter 2, the cavity 6 is mainly designed as two torus-like channels surrounding the recess 7, which are each connected to the supply line 4 and discharge line 5 on opposite sides with respect to the first transverse axis X.

All embodiments of a temperature conditioned pressure sensor 1 comprising an adapter 2 can have one or more further advantageous features. This does not only apply to the embodiments shown in the figures.

Advantageously, the adapter 2 is designed to be weld-free and solder-free. As shown in FIGS. 1 to 25, the adapter 2 itself does not have any welded or soldered connections. A possible form-fit or force-fit or material-fit connection of conduit sections 17 to the adapter 2 in the area of the supply line 4 and/or the discharge line 5 do not argue against this property of the adapter 2.

Advantageously, the adapter 2 is manufactured using an additive manufacturing process. The embodiments shown in FIGS. 1 to 25 exhibit complex geometries of the cavity 6. Said cavity 6 is thus formed free of any limitation by manufacturing methods. For example, in the embodiments of FIGS. 1 to 3 and FIGS. 11 to 20, the cavity 6 is designed in the form of two channels, between which the adapter 2 comprises solid material. This complex design increases the stability of the adapter 2. Using conventional machining production methods the adapter 2 shown in FIGS. 6 to 8 cannot be manufactured in an integral formed manner as a unitary body. For example, only cavities 6 with straight channels, i.e. straight holes, can be realized in integrally formed conventional components. The adapter 2 in FIGS. 6 to 8, which is produced using additive manufacturing methods, comprises several helical or curved channels as cavities 6. And the embodiments of the adapters 2 of FIGS. 1 to 3 and 11 to 13 have a cavity 6 in the form of several partial channels, which split from inlet 4 or outlet 5 or combine to form a channel.

Furthermore, the adapter 2 is advantageously made of a metallic material. A metallic material is advantageous because metallic materials generally have good thermal conductivity. This means that thermal energy can be easily conducted between the pressure sensor 3 in the recess 7 through the material of the adapter 2 and the temperature conditioning medium 8. The recess 7 of the adapter 2 is therefore designed to fit as precisely as possible in order to ensure good heat transfer. Good heat transfer between adapter 2 and pressure sensor 3 also takes place in the area of the connecting means 21, 31, where adapter 2 and pressure sensor 3 are intrinsically in contact with each other. In the area between adapter 2 and pressure sensor 3, which is sealed from direct contact with the measuring medium 9 by a sealing element 16, a thermally conductive paste or the like can optionally be added.

However, application areas in which the adapter 2 is made of a ceramic or a plastic are also conceivable. Thus, for example, when using a temperature conditioned sensor 1 close to high electrical voltages, both the adapter 2 and the pressure sensor 3 and diaphragm 32 of the pressure sensor 3 are made of a plastic, such as thermoplastics or thermosets. Suitable additive manufacturing processes are known to the person skilled in the art.

Advantageously, the adapter 2 is made of a material with a thermal conductivity greater than 30 W·(m·K)⁻¹. A high thermal conductivity greater than 30 W·(m·K)⁻¹ is advantageous, since the adapter 2, which is connected to the pressure sensor 3 in a thermally conductive manner, effectively supplies or removes thermal energy. Examples of a material are pure metals such as copper, aluminum, magnesium or metal alloys, for example a copper alloy, bronze, etc., or graphite. Graphite, in particular, is readily available, inexpensive and has high thermal conductivity.

The adapter 2 is particularly advantageously made of a material with a melting point above 600° C. and with a density of less than 5 g cm⁻¹. The melting point above 600° C. permits use in connection with hot gases, wherein the gases can have a temperature above 600° C., since the adapter 2 can be effectively cooled. The low density below 5 g cm⁻¹ makes it possible to build a lightweight adapter 2 in applications where weight or inertia play a major role, for example in space travel in connection with rocket engines. Depending on the desired temperature resistance, suitable materials include aluminum, magnesium, titanium or graphite (with the exclusion of oxygen).

The adapter 2 is also particularly advantageously made of a material with a density of less than 5 g cm⁻¹ and a thermal conductivity of greater than 30 W (m·K)⁻¹. This combines the advantageous lightweight construction with efficient temperature conditioning of the pressure sensor 3.

The adapter 2 is particularly advantageously made of a metallic material. A metallic material is advantageous since metallic materials generally have good thermal conductivity. This means that thermal energy can be easily conducted between the pressure sensor 3 in the recess 7 through the material of the adapter 2 and the temperature conditioning medium 8. The above-mentioned additive manufacturing processes are advantageous for an adapter 2 made of a metallic material.

The adapter 2 can also be made of a material that is known for a pressure sensor 3 or a sensor housing, for example pure metals such as titanium, copper, silver, aluminum, etc. or metal alloys such as copper alloys or 17-4PH, or 304 or 316L, etc. The material 17-4PH or 316L, also known to the person skilled in the art as steel 1.4548 or 1404 according to DIN EN 10027, is particularly advantageous, as pressure sensors often comprise a housing made of this material. In this case, the adapter 2 and the pressure sensor 3 exhibit the same thermal expansion when the temperature changes, which prevents stresses between the adapter 2 and the pressure sensor 3. The person skilled in the art selects a suitable material depending on the requirements in favor of corrosion resistance and thermal conductivity and the cost of the adapter 2.

Thus, for example, gold and copper exhibit a very high thermal conductivity greater than 200 W·(m·K)⁻¹ (Watts per meter and Kelvin). Gold and titanium are highly resistant to corrosion. Aluminum, titanium and magnesium, on the other hand, have a low density of less than 5 g cm⁻¹ (grams per cubic centimeter). Thus, relatively light adapters 2 can be realized.

In a particularly advantageous manner the adapter 2 is made in a seal-free manner. Thereby, the cavity 6 is not sealed by a sealing element to the measuring medium 9 or to an environment, with the exception of the connection of supply line 4 with a conduit section 17 and discharge line 5 with a conduit section 17. This is advantageous because no further seals are required, thus avoiding the failure of a seal and any leakage.

In a particularly advantageous manner, said adapter 2 is manufactured using one of the above-mentioned metal 3D printing processes. Thus, complex geometries of the adapter 2 and the cavity 6 can easily be realized from a metallic material.

Preferably, a wall 61 of the cavity 6, in short cavity wall 61, at least partially exhibits a surface roughness R_{z} greater than 10 μm. Particularly preferred, the cavity wall 61 at least partially exhibits a surface roughness R_{z} according to DIN EN ISO 4288 between R_{z}=20 μm and R_{z}=1000 μm. This microstructuring of the cavity wall 61 is advantageous because the roughness of the cavity wall 61 causes turbulence in the temperature conditioning medium 8 flowing through the cavity 6. The turbulence causes mixing of the temperature conditioning medium 8, which as a result dissipates or supplies more thermal energy to the adapter 2. It has been shown that the heat transfer with a surface roughness R_{z} according to DIN EN ISO 4288 between R_{z}=20 μm and R_{z}=1000 μm of the cavity wall 61 is more than 20% higher compared to conventionally manufactured adapters with a surface roughness R_{z}<2 μm. Such a surface roughness can be achieved directly by 3D printing or by chemical etching.

Advantageously, a three-dimensional structure 62 is at least partially arranged in the cavity 6, for example a porous, sponge-like material. The tempering medium 8 can flow through the three-dimensional structure 62. The structure 62 causes further turbulence of the temperature conditioning medium 8 and thus better mixing of the same. This further increases the transfer of thermal energy between the temperature conditioning medium 8 and the cavity wall 61.

In a particularly advantageous manner, the three-dimensional structure 62 is implemented as a triply periodic minimal surface, TPMS for short, as it is shown in FIGS. 26 to 29. A TPMS structure 62 is composed of three-dimensional cells which are usually arranged in a spatially periodic manner. A mathematical description and option for generating digital CAD drawings required for 3D printing is known to the person skilled in the art, for example in the publication Al-Ketan O, Abu Al-Rub R K. MSLattice: A free software for generating uniform and graded lattices based on triply periodic minimal surfaces. Mat Design Process Comm. 2020.

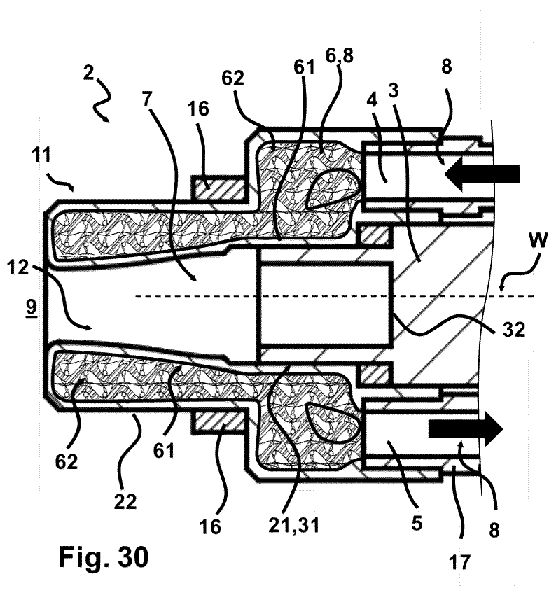

Thereby, the TPMS structure 62 can be made of a plastic or a metallic material or graphite. The TPMS structure 62 is at least partially arranged in the cavity 6. FIG. 30 shows in a cross-sectional view intended as a schematic representation of an exemplary embodiment of an adapter 2 with TPMS structure 62 arranged in a generic cavity 6, which most closely, but not exactly, resembles the cavity 6 shown in FIGS. 1-3. Of course, the arrangement of a TPMS structure 62 is not limited to the embodiment shown.

Preferably, the TPMS structure 62 is made of the same material as the adapter 2. Thus, stresses between the cavity wall 61 and TPMS structure 62 are avoided. The transfer of thermal energy between the temperature conditioning medium 8 and the adapter 2 is further increased by the TPMS structure 62 arranged in the cavity 6. The degree of turbulence and the associated pressure loss between supply line 4 and discharge line 5 can be precisely adjusted, in particular by dimensioning the individual cells and cavities 6. The cooling capacity, heating capacity or temperature conditioning capacity per installation space of the adapter 2 is thus maximized in a simple and efficient manner.

Advantageously, the structure 62 is designed in an integral formed manner with the adapter 2. This is possible in particular in conjunction with metal 3D printing processes. Thus, the TPMS structure 62 can be created directly with the adapter 2. This enables optimum heat transfer between TPMS structure 62 and cavity wall 61.

In particular, the surface roughness between R_{z}=20 μm and R_{z}=1000 μm of the cavity wall 61 is also advantageous for the surface of the TPMS structure 62. This ensures further turbulence of the temperature conditioning medium 8.

Of the known TPMS structures 62 known as Gyroid, Diamond, Primitive, I-WP, Neovius, S, F-RD, and PMY described in the above-mentioned publication, the TPMS structure 62 known as Diamond (Schwarz-Diamond) with its sub-variants has proven to be particularly advantageous, since it has a high surface area, whereby a heat transfer can be realized well, the temperature conditioning medium 8 is mixed well and at the same time can still flow through well.

In a particularly preferred manner, the cavity wall 61 does not exhibit edges with a radius of less than 0.1 mm. This has the advantage that there is no strong local turbulence. Thus, a turbulence of said temperature conditioning medium 8 is given evenly over the entire flow path.

In some embodiments, the adapter 2 has a pressure connection 11 for supplying a measuring medium 9 to the recess 7 for the pressure sensor 3. For this purpose, the pressure connection 11 comprises at least one supply channel 12. The pressure connection 11 can be connected to a measuring bore. Typically, the pressure connection 11 is connected to the measuring hole with a connecting means 22, for example with an external thread. Advantageously, the pressure connection 11 has a diameter of less than 9 mm. Since in particular M8 and smaller thread diameters according to DIN 13 or ¼ inch and smaller thread diameters according to the Unified Thread Standard are widely used as measuring bores, the pressure connection 11 particularly preferably comprises an M8 external thread or ¼ inch external thread. The thread specification includes standard threads, fine threads and, if necessary, extra fine threads. Relevant here are the following: ASME/ANSI B1.1-2019 Unified Inch Screw Threads, UN, UNR, & UNJ Thread Form; ASME/ANSI B1.2-1983 Gauges And Gauging For Unified Inch Screw Threads; and ASME/ANSI B1.3-2007 Screw Thread Gauging Systems for Acceptability: Inch and Metric Screw Threads (UN, UNR, UNJ, M, and MJ). This has the advantage that the adapter 2 can be used in particular in confined spaces. Thus, the recess 7 is designed in such a way that it has, for example, an M5 internal thread according to DIN 13 as a connecting means 21. DIN 13 refers to an industry standard DIN 13-1-ISO general purpose metric screw threads-Part 1: Nominal sizes for coarse pitch threads; nominal diameter from one millimeter to 68 mm. A pressure sensor 3 such as described in applicant's commonly owned US Patent Application Publication No. 2002-0146355, which is hereby incorporated herein in its entirety for all purposes, with an M5 external thread can then desirably be inserted into the recess 7 as connecting means 31.

The adapter 2 is preferably used with a pressure sensor 3 for temperature conditioning thereof in a temperature conditioning combination 1. The temperature conditioning combination 1 therefore comprises an adapter 2 for cooling or heating or temperature conditioning of a pressure sensor 3 and a pressure sensor 3, wherein the pressure sensor 3 is designed to be largely rotationally symmetrical along a longitudinal pressure sensor axis W. The pressure sensor 3 comprises a pressure-sensitive surface 32, usually in the form of a diaphragm 32, at a first end 71 along the longitudinal axis W of the pressure sensor. Said pressure sensor 3 can be inserted into the recess 7 of the adapter 2, whereby the longitudinal axis W of the pressure sensor is aligned parallel to the longitudinal axis Z. Pressure sensor 3 and adapter 2 can be connected in a pressure-tight manner.

In this document also embodiments are explicitly included which comprise a combination of the features of the embodiments described herein.

### LIST OF REFERENCE CHARACTERS

X First transverse axis
Y Second transverse axis
Z Longitudinal axis
W Longitudinal axis of the pressure sensor 3
1 Combination adapter 2 and pressure sensor 3
2 Adapter
3 Pressure sensor, sensor
4 Supply line
5 Discharge line
6 Cavity
7 Recess
8 Temperature conditioning medium
9 Measuring medium
11 Pressure connection
12 Supply channel
13 Pressure connection wall/channel wall
14 Sleeve
15 Sleeve location for Temperature sensor
16 Sealing element
17 Conduit section
21 Connecting means
22 Connecting means
23 Contact opening
31 Connecting means
32 Pressure-sensitive surface/diaphragm
61 Cavity wall
62 Three-dimensional structure/TPMS
71 First end
72 Second end

What is claimed is:

1. Adapter for circulating a fluid temperature conditioning medium to cool or heat a pressure sensor, the adapter comprising:
a supply line defined by the adapter;
a discharge line defined by the adapter;
a cavity defined by the adapter integrally with the supply line and the discharge line in a manner connecting the supply line and the discharge line in such a way that the fluid temperature conditioning medium can be circulated from the supply line through the cavity to the discharge line;
a recess defined by the adapter integrally with the supply line, the discharge line and the cavity and configured to elongate along a longitudinal axis and having a first end disposed spaced apart from a second end along the longitudinal axis, wherein when in use the first end of the recess faces a measuring medium and the second end of the recess is configured to receive therein the pressure sensor; and
wherein the cavity is configured to surround the recess so that the temperature conditioning medium can flow within the cavity and around the recess in a recirculating manner.

2. Adapter according to claim 1, wherein the adapter is designed to be weld-free and solder-free.

3. Adapter according to claim 1, wherein the adapter is manufactured using an additive manufacturing process.

4. Adapter according to claim 1, wherein the adapter is made of a metallic material.

5. Adapter according to claim 1, wherein the adapter is implemented to be seal-free.

6. Adapter according to claim 1, wherein said adapter is manufactured using a metal 3D printing process.

7. Adapter according to claim 1, further comprising a cavity wall that at least partially defines the cavity and at least partially exhibits a surface roughness R_{z} between 20 μm and R_{z}=1000 μm.

8. Adapter according to claim 1, further comprising a three-dimensional structure in the form of a porous, sponge-like material that is arranged at least partially in the cavity; and wherein the sponge-like material is configured to allow the temperature conditioning medium to flow through the three-dimensional structure.

9. Adapter according to claim 8, wherein the three-dimensional structure is implemented as TPMS (triply periodic minimal surfaces); and wherein the TPMS are made of a plastic or a metallic material.

10. Adapter according to claim 8, wherein the three-dimensional structure is implemented in an integrally formed manner with said adapter.

11. Adapter according to claim 1, further comprising a plurality of stability elements disposed in the cavity, which is at least partially defined by a cavity wall with a curvature having a radius of no less than 0.5 mm; wherein the cavity wall is defined at least partially in the form of a hollow cylinder; wherein several of the plurality of stability elements are arranged in the hollow cylinder.

12. Adapter according to claim 1, wherein the adapter is made of a material with a thermal conductivity greater than 30 W·(m·K)⁻¹; or wherein the adapter is made of a material with a melting point above 600° C. and with a density of less than 5 g cm⁻¹.

13. Adapter according to claim 1, further comprising a pressure connection connected to the recess and configured for supplying a measuring medium to the recess for the pressure sensor; wherein the pressure connection comprises a supply channel; wherein the pressure connection is configured to be connected to a measuring bore; and wherein the pressure connection exhibits a maximum diameter of 9 mm.

14. Adapter according to claim 1, further comprising a sleeve that is implemented in an integrally formed manner with the adapter; wherein the sleeve is configured to receive a temperature sensor; and wherein the sleeve protrudes into the measuring medium when the adapter is used and is hermetically sealed with respect to the measuring medium.

15. Kit-of-parts of a temperature conditioning combination, comprising:
an adapter for circulating a fluid temperature conditioning medium for cooling or heating a pressure sensor and defining a wall that defines a recess, wherein the adapter elongates along a longitudinal axis;
a pressure sensor;
wherein the wall comprises a mounting bore;
wherein the pressure sensor is implemented to be largely rotationally symmetrical along a longitudinal pressure sensor axis;
wherein the pressure sensor comprises a pressure-sensitive surface at a first end along the longitudinal pressure sensor axis;
wherein the pressure sensor can be inserted into the recess of the adapter;
and wherein the longitudinal axis of the pressure sensor is aligned parallel to the longitudinal axis of the adapter;
wherein the pressure sensor and the adapter are configured for connection in a pressure-tight manner;
wherein the adapter integrally defines a supply line, a discharge line a cavity connected between the supply line and the discharge line, and a recess having one end that receives the pressure sensor, wherein the cavity is configured to surround the recess so that the temperature conditioning medium can flow within the cavity and around the recess in a recirculating manner.

16. Adapter according to claim 1, wherein the adapter is made of a material with a thermal conductivity greater than 30 W·(m·K)⁻¹ and comprises pure copper, pure aluminum or pure magnesium.

17. Adapter according to claim 1, wherein the adapter is made of a material with a thermal conductivity greater than 30 W·(m·K)⁻¹ and comprises a copper alloy.

18. Adapter according to claim 1, wherein the adapter is made of a material with a thermal conductivity greater than 30 W·(m·K)⁻¹ and comprises graphite.

19. Adapter according to claim 1, wherein the adapter is made of a material with a thermal conductivity greater than 30 W·(m·K)⁻¹ and a melting point above 600° C. and with a density of less than 5 g cm⁻¹.

20. Adapter according to claim 1, wherein the adapter is made of a material with a thermal conductivity greater than 30 W·(m·K)⁻¹ and a density of less than 5 g cm⁻¹.
